(19) United States
(12) Patent Application Publication
(10) Pub. No.: US 2007/0134073 A1
(43) Pub. Date: Jun. 14, 2007

(54) Fastener

(76) Inventors: David A. Shereyk, Homewood, IL (US); Thomas A. Benoit, Bourbonnais, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/586,762

(22) Filed: Oct. 26, 2006

Related U.S. Application Data
(60) Provisional application No. 60/750,105, filed on Dec. 14, 2005.

(51) Int. Cl. F16B 19/00

(52) U.S. Cl. 411/510

(57) ABSTRACT

A tree-type fastener includes one or more fin stabilizer bases disposed on a shaft of the fastener. When the fastener is subjected to a pull-out force, the fins may be prevented from stacking up, buckling or bending by the fin stabilizer base. The stabilizer base is configured to provide no interference with a work piece when inserted in a work piece aperture. The fastener of the invention provides a high removal force to insertion force ratio and a strong, single piece device. The fastener may also be adapted for modification of new and existing tree-type fasteners.

### CROSS REFERENCE TO RELATED APPLICATIONS

This Non-Provisional Application claims benefit to U.S. Provisional Application Ser. No. 60/750,105 filed Dec. 14, 2005.

### FIELD OF THE INVENTION

The present invention relates generally to fasteners, and more particularly, to tree-type fasteners.

### BACKGROUND OF THE INVENTION

It is known that tree-type fasteners are used to join component panels, one or more work pieces, or other structures. The tree-type fastener is typically made of a plastic material and includes multiple standard retention fins located along a longitudinal shaft, the fins extending outwardly from the shaft. The fins may have a shape such as annular, flat, angled, spiral or round, to name a few. These fasteners are designed to be driven axially into an aperture to connect one or more work pieces, and the fins may engage the edges of the aperture and the work piece surfaces to join together the work pieces. Known tree-type fasteners may be found, for example, in U.S. Pat. Nos. 5,468,108, 5,907,891, and 6,669,426.

When tree-type fasteners are subjected to excessive pull-out forces the fins have a tendency to bend or flex. In these situations, the fins typically stack-up on top of each other as the fastener is pulled through the hole. The fastener end may act to increase the force necessary to pull the fastener through the hole. However, even if the fastener is prevented from being pulled out of the hole, the tree-type fastener with bent or flexed fins may now wobble in the hole due to the stack-up of the fins along the shaft. If the fastener is for an automotive component, such as a routing clip, a fastener that may wobble in the hole could lead to undesirable performance of that component. For known tree-type fasteners made of conventional plastic resins, the removal force of the fastener typically ranges from 30-60 lbs. Some current designs of tree-type fasteners utilize highly angled fins to achieve relatively greater insertion to removal ratios. Even these designs, however, typically do not reach above 50-60 lbs. of removal force.

### SUMMARY OF THE INVENTION

Aspects of the invention provide one or more robust fin stabilizer bases disposed on the shaft of the tree-type fastener. As a result, if the fastener is subjected to a pull-out force, the fin stabilizer base will prevent the fins from stacking up, buckling or caving in. The fin stabilizer base is configured to provide no interference with a panel when inserted in a mating panel aperture, and is preferably located along the shaft at a distance from the fastener head that is greater than the width of the panel and any additional components through which the fastener is to be installed.

Features of embodiments of the invention include a low required insertion force combined with a high removal force and a robust, yet clean design. Because the fastener is fabricated as a single piece, the fastener may be manufactured with a relatively low tooling investment. Features of the invention may also be adapted with new or existing tree-type fastener designs such as 2-barb, 4-barb, and split tree, among other designs.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a side view of an embodiment of the invention.

FIG. 2 is a side view of the embodiment of FIG. 1.

FIG. 3 is a cross-section view of another embodiment of the invention.

FIG. 4 is a cross-section view of a further embodiment of the invention.

FIG. 5 is a cross-section view of a still further embodiment of the invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE EMBODIMENTS

The Figures illustrate exemplary embodiments of tree-type fasteners of the invention. These embodiments may include a fin stabilization base, also referred to as a fin stabilizer or force multiplier base, located at one or more desired positions along the fastener shaft. In one embodiment, the fin stabilizer is located at a distance below the known work piece thickness of the application, as well as below any additional components attached to the work piece by the fastener. At this location, the fin stabilizer acts as a stop or support structure for the fins by supporting the underside of the fins to prevent the fins from rolling over or stacking-up one on top of another. By placing a fin stabilizer strategically along the shaft, the extraction force required to remove the fastener will significantly increase and wobbling due to damaged fins may also be prevented. It should be understood that additional fin stabilizers may be utilized to further increase the extraction force required to extract the fastener. These fin stabilizers may be positioned at any location along the shaft and between each component that is fastened together.

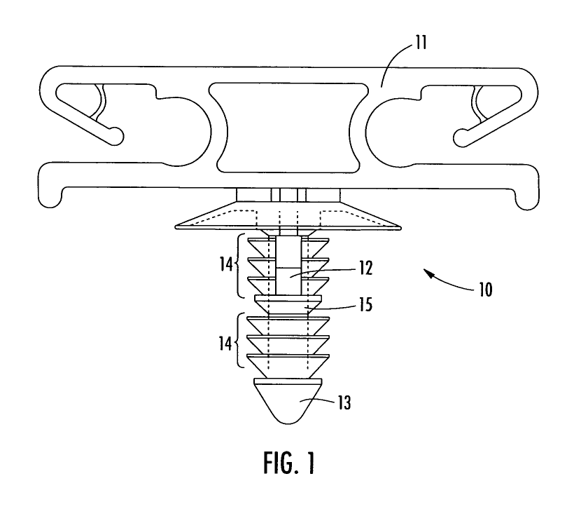

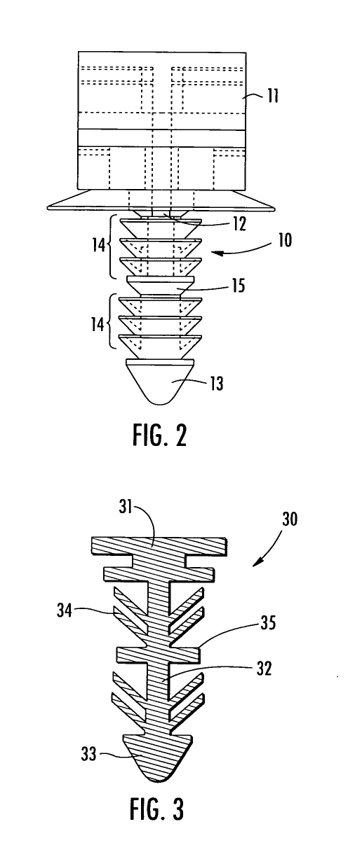

Referring to FIGS. 1 and 2, an exemplary embodiment of a tree-type fastener 10 is illustrated. Fastener 10 may include a head 11 disposed at the top of a shaft 12 and an end piece 13 disposed at the bottom of the shaft 12. The head 11 may define any suitable configuration or shape. The end piece 13 also may have any suitable configuration or shape including the depicted substantially conical shape with the wider end attached to the shaft and the narrower end pointed down along the axis as the shaft. Fins 14 may be disposed on the shaft at a predetermined longitudinal spacing from each other and extending outwardly from the shaft in a generally perpendicular manner or at an angle. The embodiment shown in FIG. 1 illustrates two types of fins 14, one group disposed on the lower half of the shaft 12 and extending around the full shaft circumference, and the other group comprising two sets of fins 14 disposed on opposite surfaces of the shaft 12 without contacting the shaft surfaces that are located intermediate of the fin sets. It should be understood that the fins 14 may define any suitable shape, may be positioned at any location on the fastener shaft 12, and may define any extension angle or multiple extension angles with respect to the shaft 12.

A fin stabilization base 15 or fin stabilizer may be disposed on the shaft 12 and may extend generally perpendicular to the shaft 12. The stabilization base 15 may be positioned on the shaft 12 in a longitudinal gap between two fins 14. The stabilization base 15 may define a truncated conical shape as illustrated in FIG. 1, though other shapes and configurations of the base 15 are possible and may be used with the invention. The fin stabilization base 15 is configured to have a diameter that is less than the diameter of the work piece to which the fastener is mounted. With this configuration, there will be no interference between the stabilization base 15 and the aperture edges during installation of the fastener 10. Consequently, the stabilization base 15 will not significantly increase the insertion force required to insert the fastener 10 through the aperture as compared to a conventional tree-type fastener that does not include a stabilization base 15. This allows the fastener 10 to be installed with a low ergonomic force, in the range of approximately 5 and 15 lbs. In alternative embodiments of the invention that may use multiple fin stabilization bases 15 disposed on the fastener shaft, each stabilization base may define a diameter that is smaller than the diameter of the aperture to which the fastener is mounted to thereby provide a low required insertion force for the fastener.

The fin stabilization base 15 generally functions as a fin stop support and further as an extraction force multiplier. As the fins 15 buckle or bend during extraction of the fastener, the fin stabilization base 15 will cause any buckling or bending of the fins to slow or stop. In some embodiments, with the use of the fin stabilization base 15, the extraction or removal force required to remove the fastener from the aperture to which it is mounted may increase significantly to well over 70 lbs in some embodiments and, in other embodiments, to over 100 lbs. By adding at least one fin stabilization base 15, significantly greater extraction forces will now be required to remove the fastener from the aperture to which the fastener is mounted.

The fin stabilization base 15 may be embodied in numerous configurations, including as a ring, square, triangle, or any other robust or solid base shape. An object of the invention is to achieve significant removal-to-insertion force ratios. This may be accomplished by varying the location and number of fin stabilization bases on each fastener. This is, of course, dependant on the specific panel and aperture dimensions, and any other unique application requirements. The placement of at least one fin stabilization base 15 at one or more intervals along the shaft allows the fastener 10 to achieve a high retention force at low insertion force levels. In addition, the end piece 13 shown in FIG. 1 may also act as a force multiplier. If fins 14 are disposed sufficiently near the end of the shaft to receive support from the end piece 13, upon application of a removal or extraction force, the end piece 13 will function as a stop to prevent buckling or bending of the fins and thereby increase the extraction force required for removal of the fastener.

Referring to FIGS. 3-5, there are illustrated alternative embodiments of a fastener with a fin stabilization base or a force multiplier base of the invention. These embodiments are shown in cross-section views and are similar to the embodiment of FIG. 1. The features and functions of the embodiment of FIG. 1 are expressly incorporated by reference into the alternative embodiments of FIGS. 3-5.

Referring to FIG. 3, a fastener 30 may include a head 31 disposed at the top of a shaft 32 and an end piece 33 disposed at the bottom of the shaft 32. The fastener 30 may include a “2-fin” configuration that further includes a pair of fins 34 positioned on opposing sides of a fin stabilization base 35. The fin stabilization bases 35 may be configured on the shaft 32 and may include a solid circular ring that extends around the circumference of the shaft 32.

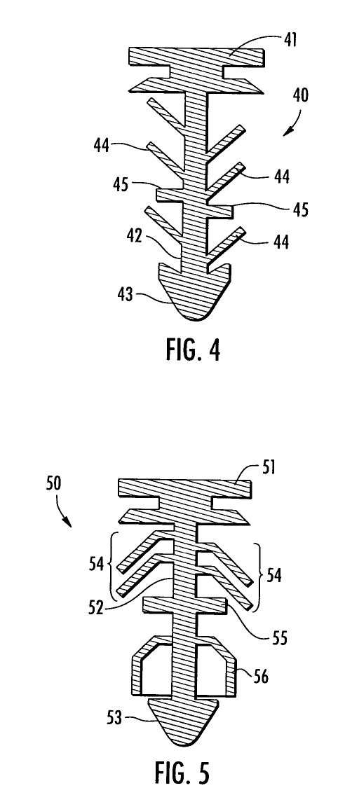

Referring to FIG. 4, a fastener 40 may be configured as a “split-tree” fastener design where fins 44 are configured on opposing sides of the shaft 42. The fins 44 may also be disposed longitudinally offset from each other. With this embodiment, two fin stabilization bases 45 may be disposed on opposite sides of shaft 42 and longitudinally offset with respect to each other. The fastener 40 may include a head 41 disposed at the top of a shaft 42 and an end piece 43 disposed at the bottom of the shaft 42.

Referring to FIG. 5, a fastener 50 may include two sets of barb-shaped fins 54 disposed on opposing sides of shaft 52. The fastener 50 may also include a solid rectangular fin stabilization base 55 positioned in a longitudinal gap between fins 54 and fin 56. The fin stabilization base 55 is disposed around the circumference of shaft 52 and extends generally perpendicular to the shaft axis. Similar to the other embodiments, the fastener 50 may include a head 51 disposed at the top of a shaft 52 and an end piece 53 disposed at the bottom of the shaft 52.

The designs of embodiments of the present invention may be implemented into all current as well as new fastener applications without significant tooling changes. The fastener does not change or affect current low ergonomic insertion requirements. The design is flexible in many various embodiments with the fin stabilization base comprising, for example, the shape of a ring, a rectangle, a triangle, a cone, a truncated cone, or more than one offset blocks or rings. The location, size and thickness of the fin stabilization base will determine the ultimate retention force. Thus, changing the location and number of bases employed and the base characteristics makes the retention force adjustable to the specific application desired.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It is also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A fastener for removable insertion into an aperture defined within a work piece, the aperture defining a diameter, the fastener comprising:
a shaft having a longitudinal axis;
a head formed on a first end of the shaft;
a plurality of fins disposed on the shaft at a predetermined longitudinal spacing from each other, the fins extending from the shaft; and
at least one fin stabilization base disposed on the shat and generally perpendicular to the shaft in a gap between the fins, the at least one base having a diameter less than the aperture diameter.

2. The fastener of claim 1 further comprising a plurality of fin stabilization bases.

3. The fastener of claim 2 further comprising an end piece with a generally conical shape having a narrow lower portion and a wider upper portion in communication with a second end of the shaft, the end piece being one of the at least one fin stabilization bases.

4. The fastener of claim 3 wherein one of the at least one fin stabilization bases is positioned between the plurality of fins and the end piece.

5. The fastener of claim 1 wherein the shape of the at least one stabilization base is selected from the group consisting of a ring, a rectangle, a triangle, a cone, and a truncated cone.

6. A fastener for use in securing a component to a work piece by insertion into a hole provided therein, comprising:
a shaft having a longitudinal axis;
a head disposed on a first end of the shaft;
a first set of fins disposed on a first surface of the shaft at a predetermined longitudinal spacing from each other, the fins extending radially from the shaft at a first angle;
a first fin stabilization base disposed on and generally perpendicular to the first surface of the shaft in a gap between the fins, the first base having a diameter such that the first base does not interfere with the work piece during insertion into the hole;
a second set of fins disposed on a second surface of the shaft, opposite the first surface, the fins extending radially from the shaft; and
a second fin stabilization base disposed on and generally perpendicular to the second surface of the shaft in a gap between the fins, the second base having a diameter such that the second base does not interfere with the work piece during insertion into the hole.

7. The fastener of claim 6 wherein the second set of fins extends from the shaft at a second angle.

8. The fastener of claim 6 wherein the component and the panel are located between the head and at least one of the first or second stabilization bases when the fastener is inserted into the hole.

9. The fastener of claim 8 further comprising an end piece positioned on a second end of the shaft.

10. The fastener of claim 6 wherein the second set of fins is disposed on the second surface of the shaft at an offset longitudinal position relative to the position of the first set of fins.

11. A fastener for use in securing a component to a panel by insertion into an aperture provided therein, the aperture defining a diameter, the fastener comprising:
a shaft having an axis;
a head disposed at a first end of the shaft;
a first set of fins disposed on a first surface of the shaft below the head at a predetermined longitudinal spacing from each other, the fins extending from the shaft at an angle;
a second set of fins disposed on a second surface of the shaft, opposite the first set of fins, the second set of fins extending radially from the shaft at an angle; and
a force multiplier base disposed around the circumference of and generally perpendicular to the shaft in a first gap, the base having a diameter less than the aperture diameter.

12. The fastener of claim 11 wherein the shape of the force multiplier base is selected from the group consisting of a ring, a rectangle, a triangle, a cone, and a truncated cone.

13. The fastener of claim 11 wherein the component and the panel are located between the force multiplier base and the head when the fastener is inserted into the aperture.

14. The fastener of claim 13 wherein the force required to remove the fastener from the panel aperture is equal to or greater than 70 pounds.

15. The fastener of claim 11 further comprising a second force multiplier base disposed on the shaft in a second gap, the second base having a diameter less than the aperture diameter.

16. The fastener of claim 11 comprising a plurality of force multiplier bases disposed in a plurality of gaps between fins on the shaft, the plurality of bases each having a diameter less than the aperture diameter.

17. The fastener of claim 16 further comprising an end piece disposed on a second end of the shaft, the end piece being one of the plurality of force multiplier bases.

18. The fastener of claim 17 wherein one of the fins of either of the first or second sets of fins is positioned adjacent the end piece.

19. The fastener of claim 18 wherein the shape of the force multiplier base is selected from the group consisting of a ring, a rectangle, a triangle, a cone, and a truncated cone.

20. The fastener of claim 19 wherein at least one of the plurality of force multiplier bases extends substantially perpendicular from the shaft.
